(19) United States
(12) Patent Application Publication
(10) Pub. No.: US 2013/0322084 A1
(43) Pub. Date: Dec. 5, 2013

(54) LIGHTING DEVICE

(71) Applicant: Osamu EBISAWA, Kanagawa-ken (JP)

(72) Inventor: Osamu EBISAWA, Kanagawa-ken (JP)

(73) Assignee: Toshiba Lighting & Technology Corporation, Kanagawa-ken (JP)

(21) Appl. No.: 13/602,060

(22) Filed: Aug. 31, 2012

(30) Foreign Application Priority Data
May 29, 2012 (JP) 2012-122304

(51) Int. Cl. F21V 21/30; F21V 9/08

(52) U.S. Cl. 362/269; 362/427; 29/592

(57) ABSTRACT

Alighting device includes a decoration frame, a light source unit, and a rotating ring. The decoration frame has a cylindrical shape in which a through-hole is formed. The light source unit is mounted with a light-emitting element. The rotating ring includes a supporting section configured to support the light source unit to be capable of rotating about a rotation axis that connects opposed positions of an inner wall of the rotating ring, a first annular section configured to form an inner wall that is flush with the through-hole of the decoration frame and slide on the edge of the through-hole to be capable of pivoting integrally with the light source unit, and a second annular section formed in an inner diameter larger than the inner diameter of the first annular section and configured to surround at least a part of the outer wall of the decoration frame.

### CROSS-REFERENCE TO RELATED APPLICATIONS

This application is based upon and claims the benefit of priority from Japanese Patent Application No. 2012-122304, filed on May 29, 2012; the entire contents of which are incorporated herein by reference.

### FIELD

Embodiments described herein relate generally to a lighting device.

### BACKGROUND

In the past, a lighting device including semiconductor light-emitting elements such as LEDs (Light Emitting Diodes) as a light source is used. As such a lighting device, there is a lighting device in which a lighting appliance including a light source is provided to be rotatable with rotation axes set in the vertical direction and the horizontal direction of a lighting device body. For example, there is a lighting device that enables rotation of a lighting appliance using plural protruding sections protruding from the inner wall of a reflector. However, in such a lighting device, light from a light source lights the protruding sections depending on an angle of the lighting appliance. Therefore, stable light cannot always be provided to the inside of a room or the like.

### DESCRIPTION OF THE DRAWINGS

FIG. 1 is a perspective view of an example of the external appearance of a lighting device according to an embodiment;

FIG. 2 is a perspective view of the example of the external appearance of the lighting device;

FIG. 3 is a perspective view of an example of the external appearance of the lighting device;

FIG. 4 is a perspective view of the example of the external appearance of the lighting device;

FIG. 5 is a perspective view of an example of the external appearance of the lighting device;

FIG. 6 is a perspective view of an example of a light source unit in a disassembled state according the embodiment;

FIG. 7 is a perspective view of an example of the lighting device in a disassembled state;

FIG. 8 is an enlarged perspective view of an example of the external appearance of a rotating ring according to the embodiment;

FIG. 9 is a perspective view of an example of the lighting device in a disassembled state;

FIG. 10 is an enlarged perspective view of an example of the external appearance of the rotating ring and a decoration frame according to the embodiment;

FIG. 11 is an enlarged view of a protruding section formed in a base member according to the embodiment;

FIG. 12 is a schematic diagram of a cross section of the rotating ring and the decoration frame;

FIG. 13 is an enlarged perspective view of an example of the external appearance of a base member according to the embodiment;

FIG. 14 is an enlarged perspective view of an example of the external appearance of a variable color filter according to the embodiment;

FIG. 15 is an enlarged perspective view of the example of the external appearance of the variable color filter;

FIG. 16 is an enlarged perspective view of an example of the external appearance of a base member mounted with the variable color filter;

FIG. 17 is a schematic diagram of a cross section taken along line I-I illustrated in FIG. 16; and

FIG. 18 is a schematic diagram of a cross section taken along line II-II illustrated in FIG. 16.

### DETAILED DESCRIPTION

In general, according to one embodiment, there is provided a lighting device that can perform stable lighting using a rotatable light source.

In a lighting device 1 according to an embodiment explained below, a through-hole 300a is formed in a cylindrical decoration frame 300. A light source unit 100 is mounted with light-emitting elements. A rotating ring 200 includes supporting sections 221a and 221b configured to support the light source unit 100 to be rotatable about a rotation axis that connects opposed positions of the inner wall of the rotating ring 200, a first annular section 261 having an inner wall that forms an opening that is contiguous with the through-hole 300a of the decoration frame 300 and is configured to slide on an edge 320 of the decoration frame 300, and a second annular section 262 formed with an inner diameter larger than the inner diameter of the first annular section 261 and configured to surround at least a part of an outer wall 301 of the decoration frame 300.

In the embodiment explained below, one ends of fixing metal fittings 411, 412, and 413 are attached to the outer wall 301 of the decoration frame 300 and the other ends thereof cover the second annular section 262 of the rotating ring 200.

In the embodiment explained below, the rotating ring 200 includes a protruding section 270 protruding from the second annular section 262. The decoration frame 300 includes, on the outer wall 301, a locking section 352 for locking the protruding section 270.

In the embodiment explained below, the light source unit 100 includes a cylindrical base member 120 supported by the supporting sections 221a and 221b at opposed positions of the outer wall of the base member 120. In the base member 120, cutout sections 128a and 128b are formed at the edge of a section of the base member 120 that opens in a direction toward the through-hole 300a of the decoration frame 300.

In the embodiment explained below, in the base member 120, two cutout sections 128a and 128b are formed. A straight line that connects the two cutout sections 128a and 128b and the rotation axis are substantially perpendicular to each other.

In the embodiment explained below, a variable color filter 160 configured to selectively transmits light having specific wavelength. The base member 120 includes a projecting section 124 projecting inwardly from the inner wall of the base member 120 in the inner side direction. The variable color filter 160 is sized to be inserted into an opening section formed by the projecting section 124. The variable color filter 160 is inserted from the through-hole 300a of the decoration frame 300 and inserted through the opening section of the projecting section 124, whereby projecting sections 161a and 161b projecting from the outer edge section of the variable color filter 160 are placed on the projecting section 124 of the base member 120.

In the embodiment explained below, in the base member 120, cutout sections 125a and 125b for locking the projecting sections 161a and 161b are formed in amounting surface of the projecting section 124 on which the projecting sections 161a and 161b of the variable color filter 160 are mounted.

In the embodiment explained below, the variable color filter 160 includes cutout sections 162a and 162b, a part of peripheral edges of which are cut.

In the embodiment explained below, in the base member 120, a gap is formed between the cutout sections 162a and 162b of the variable color filter 160 after the variable color filter has been mounted on the projecting section 124.

In the embodiment explained below, in the base member 120, the rear surface of the mounting surface in the projecting section 124 is formed as sloped to form the gap between the cutout sections 162a and 162b.

In the embodiment explained below, in the base member 120, flat sections 129a and 129b are formed near the cutout sections 128a and 128b on the rear surface of the mounting surface in the projecting section 124.

In the embodiment explained below, the rotating ring 200 includes a cover 210 configured to cover at least a part of the rotatable light source unit 100.

In the embodiment explained below, the cover 210 covers a gap formed between the rotated light source unit 100 and the first annular section 261.

In the embodiment explained below, the light source unit 100 includes a base material 111 fixedly provided on the base member 120 in a state in which a substrate 140 mounted with light-emitting elements is held between the base material 111 and the base member 120. The base material 111 includes a heat discharge member configured to discharge heat generated from the light source unit 100.

The lighting device according to the embodiment is explained below with reference to the accompanying drawings. In the embodiment, the same components are denoted by the same reference numerals and signs and redundant explanation of the components is omitted.

### Example of the External Appearance of the Lighting Device

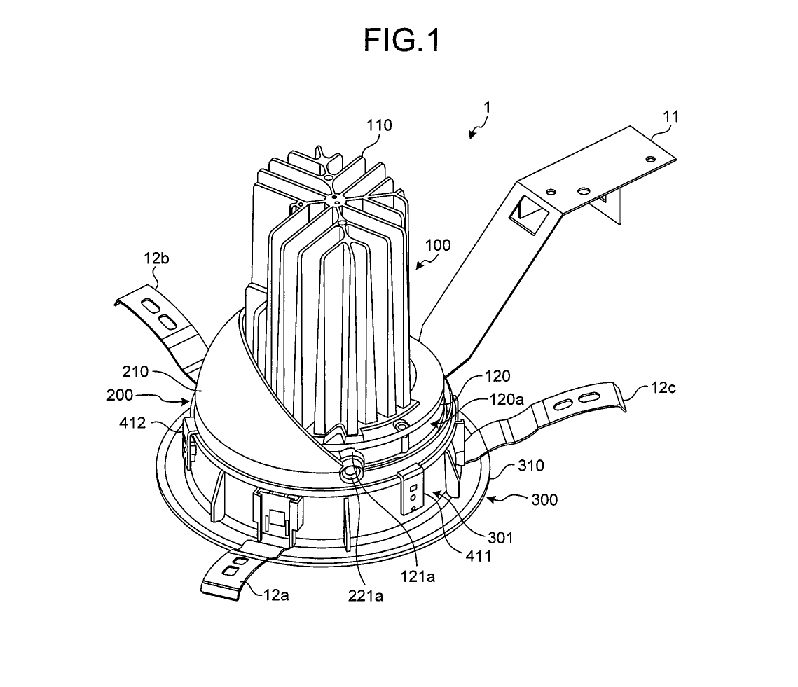

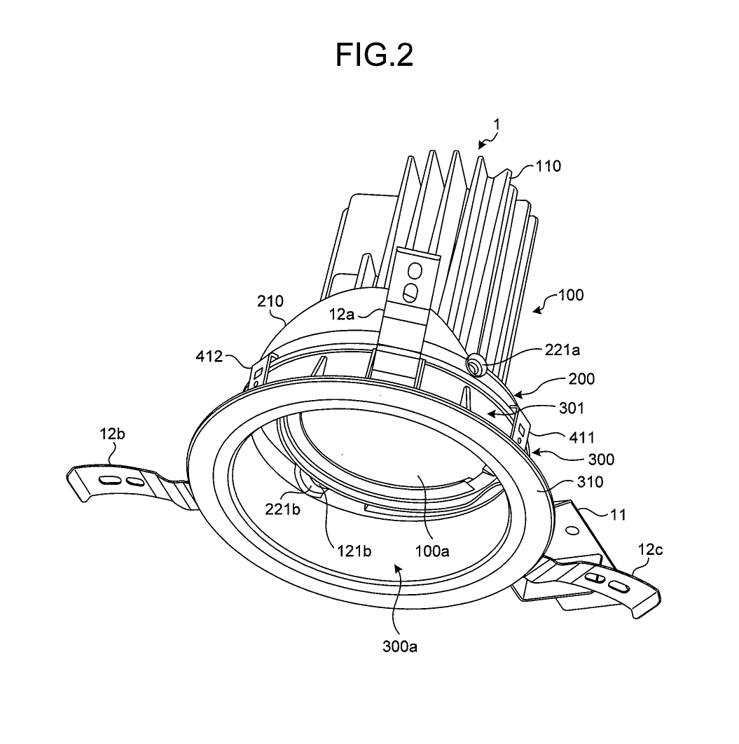

FIGS. 1 and 2 are perspective views of an example of the external appearance of the lighting device 1 according to this embodiment. In FIG. 1, an example of the lighting device 1 viewed from an oblique upward direction is illustrated. In FIG. 2, an example of the lighting device 1 viewed from an oblique downward direction is illustrated.

The lighting device 1 illustrated in FIGS. 1 and 2 is, for example, a lighting device of a downlight type embedded and set in the ceiling of a room. The lighting device 1 causes light-emitting elements such as LEDs mounted on the inside to emit light to thereby light the inside of the room or the like located in the downward direction illustrated in FIGS. 1 and 2. The lighting device 1 includes the light source unit 100, the rotating ring 200, and the decoration frame 300.

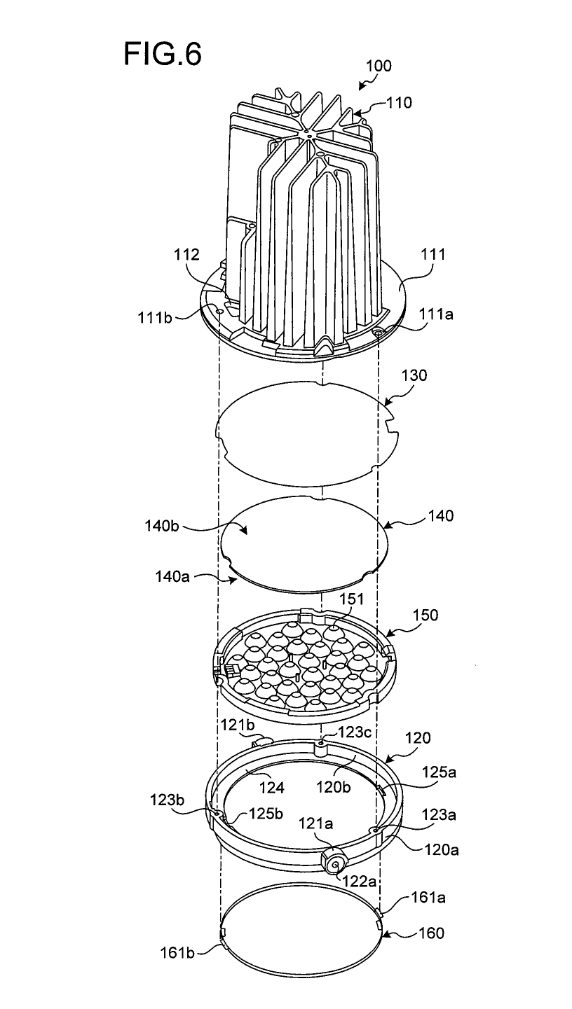

The light source unit 100 is made of metal having high heat conductivity and is molded by, for example, aluminum die-cast. As explained below with reference to FIG. 6 and the like, the light source unit 100 is formed by fixing a radiator 110 to the base member 120 by fixing screws or the like. The light source unit 100 includes, on the inside, a substrate mounted with light-emitting elements such as LEDs. The substrate is held by the radiator 110 and the base member 120. The substrate emits light in the downward direction illustrated in FIGS. 1 and 2.

The radiator 110 includes, as illustrated in FIG. 1, plural thermal radiation fins, which are plane members, vertically provided in the upward direction illustrated in FIG. 1. The radiator 110 discharges heat, which is generated from the substrate on the inside of the light source unit 100, to the outside. Consequently, the radiator 110 can suppress a temperature rise of the lighting device 1.

As explained above, the radiator 110 is fixed to the base member 120. The base member 120 includes, on an outer wall 120a, columnar protruding sections 121a and 121b protruding from the outer wall 120a (see FIG. 6). The protruding sections 121a and 121b are formed in positions opposed to each other.

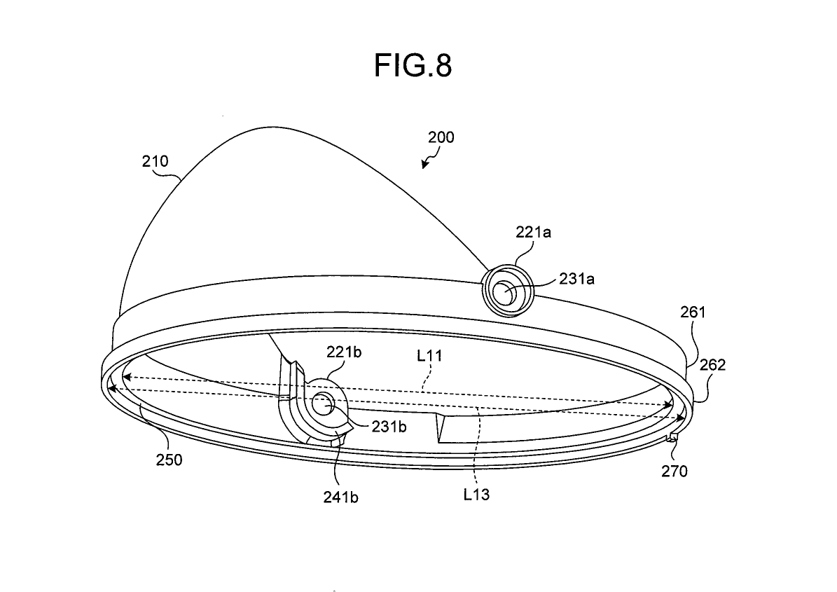

The rotating ring 200 is made of metal and molded by, for example, aluminum die-cast. The rotating ring 200 is formed in a cylindrical shape opened in a substantially circular shape at both the upper and lower ends. The rotating ring 200 includes the cover 210 configured to cover a part of the light source unit 100 (see FIG. 8). The rotating ring 200 includes, as illustrated in FIGS. 1 and 2, the supporting sections 221a and 221b in positions opposed to each other (see FIG. 8).

As explained in detail below, the protruding section 121a of the base member 120 is rotatably supported by the supporting section 221a of the rotating ring 200. The protruding section 121b of the base member 120 is rotatably supported by the supporting section 221b of the rotating ring 200. Consequently, the light source unit 100 can rotate (tilt) about a rotation axis, which is a straight line that connects the protruding section 121a and the protruding section 121b.

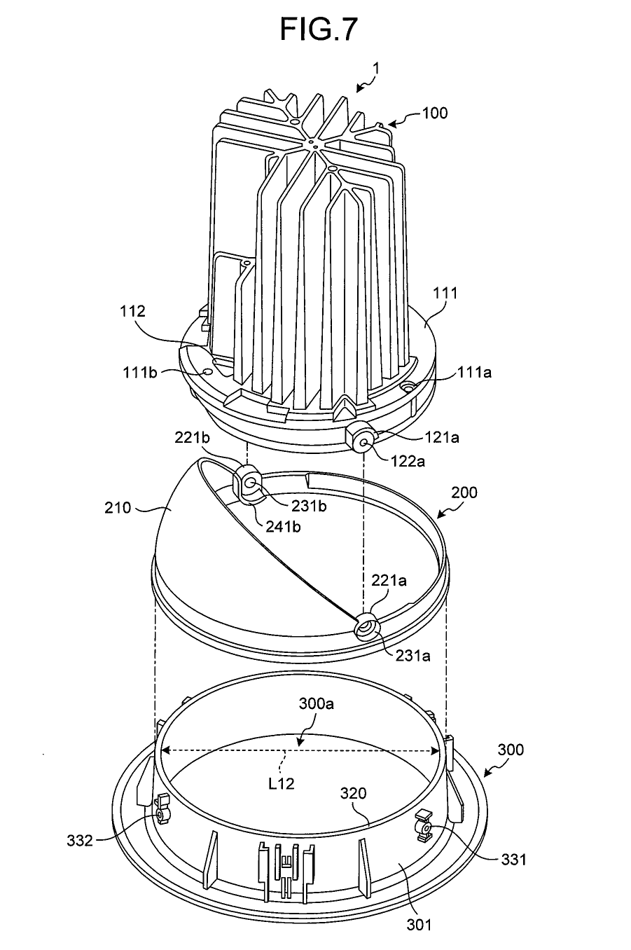

The decoration frame 300 is made of synthetic resin such as ABS resin and formed in a cylindrical shape opened in a substantially circular shape at both the upper and lower ends. Specifically, as illustrated in FIG. 2 (see also FIG. 7), the through-hole 300a is formed in the decoration frame 300. The decoration frame 300 adjusts light distribution of the light emitted by the light-emitting elements included in the light source unit 100. Specifically, as illustrated in FIG. 2, light radiated from the light-emitting surface 100a of the light source unit 100 passes through the through-hole 300a of the decoration frame 300. Therefore, an irradiation direction of the light is adjusted by the cylindrical shape of the decoration frame 300.

As explained in detail below, the fixing metal fittings 411 and 412 are attached to the decoration frame 300 in a state in which the rotating ring 200 is placed on the decoration frame 300. Further, a fixing metal fitting (the fixing metal fitting 413) not illustrated in FIG. 1 is attached to the decoration frame 300. The rotating ring 200 slides on the decoration frame 300 to thereby be capable of pivoting on the decoration frame 300 integrally with the light source unit 100.

The decoration frame 300 includes an annular flange 310 projecting outward from the lower end of the outer wall 301. In the decoration frame 300, a top plate 11 and attachment springs 12a to 12c are attached to the outer wall 301.

A not-illustrated terminal block is attached to the top plate 11. The terminal block is connected to a not-illustrated commercial alternating-current power supply via a connection line (a harness). The terminal block is connected to a substrate included on the inside of the light source unit 100 via a connection line. Consequently, the terminal block relays power supply from the commercial alternating-current power supply to the substrate.

The attachment springs 12a to 12c are elastic members of metal plates. The attachment springs 12a to 12c are pressed in the upward direction from the outside in an attached state to the outer wall 301 of the decoration frame 300, whereby the attachment springs 12a to 12c can bend to a position substantially parallel to the outer wall 301 of the decoration frame 300. If the lighting device 1 is embedded and set in the ceiling, the lighting device 1 is inserted into an embedding hole of the ceiling wall in a state in which the attachment springs 12a to 12c are bent to the position substantially parallel to the outer wall 301 of the decoration frame 300. The lighting device 1 is pushed up until the annular flange 310 comes into contact with the ceiling. Since the attachment screws 12a to 12c are not pressed from the outside anymore, the attachment screws 12a to 12c are restored to the state illustrated in FIG. 1. The attachment screws 12a to 12c hold the ceiling wall between the attachment screws 12a to 12c and the annular flange 310. Consequently, the lighting device 1 is embedded and set in the ceiling.

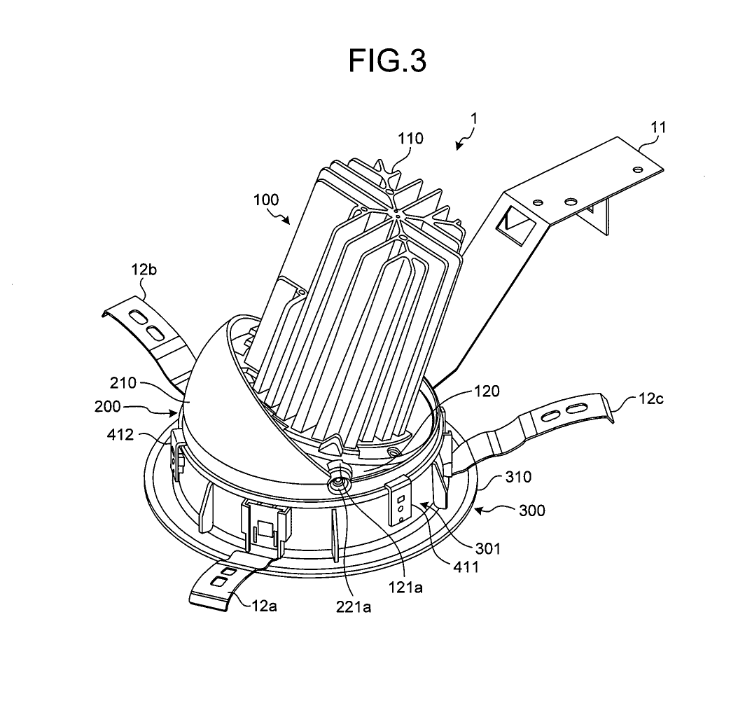

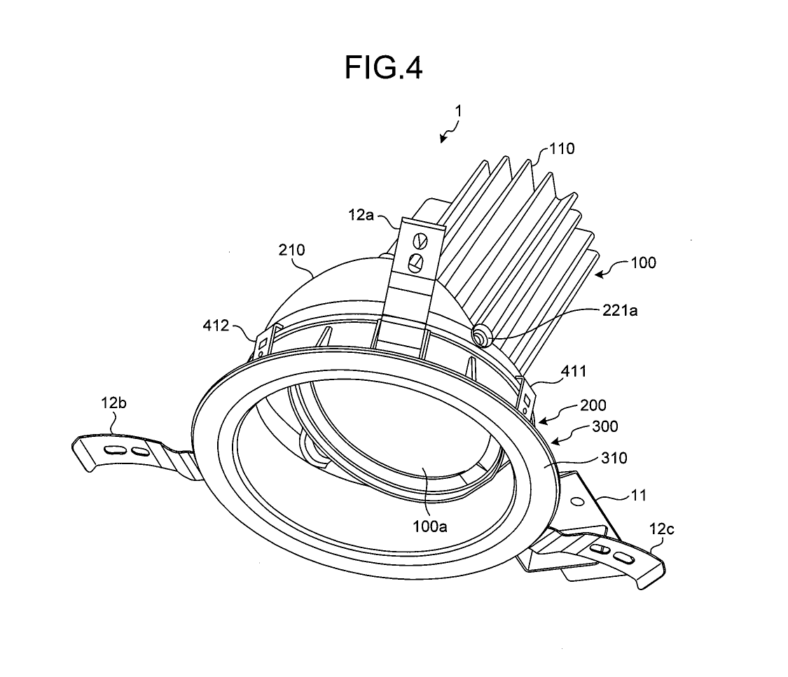

As explained above, in the lighting device 1 according to this embodiment, the light source unit 100 can tilt about the rotation axis, which is the straight line that connects the protruding section 121a and the protruding section 121b. This point is explained with reference to FIGS. 3 and 4. FIGS. 3 and 4 are perspective views of an example of the external appearance of the lighting device 1 according to this embodiment. In FIG. 3, an example of the lighting device 1, which is in a state in which the light source unit 100 tilts, viewed from an oblique upward direction is illustrated. In FIG. 4, an example of the lighting device 1 in FIG. 3 viewed from an oblique downward direction is illustrated.

In the lighting device 1 illustrated in FIG. 3, compared with the lighting device 1 illustrated in FIG. 1, the light source unit 100 is tilted. Specifically, in the lighting device 1 illustrated in FIG. 1, a direction in which the thermal radiation fins formed in the radiator 110 are vertically provided and the annular flange 310 (i.e., the ceiling) are substantially perpendicular (about 90°) to each other. On the other hand, in the lighting device 1 illustrated in FIG. 3, the direction in which the thermal radiation fins are vertically provided and the annular flange 310 are not substantially perpendicular (about 90°) to each other. An upper part of the light source unit 100 tilts in a direction away from the cover 210.

If the light source unit 100 tilts as illustrated in FIG. 3, as illustrated in FIG. 4, the light-emitting surface 100a of the light source unit 100 tilts from the state illustrated in FIG. 2. Specifically, in the example illustrated in FIG. 2, the light-emitting surface 100a is substantially parallel to the annular flange 310. However, in the example illustrated in FIG. 4, the light-emitting surface 100a is not substantially parallel to the annular flange 310. An angle formed by the light-emitting surface 100a and the annular flange 310 is larger than an angle in the state illustrated in FIG. 2. In other words, the light source unit 100 irradiates light in different directions in the state illustrated in FIG. 2 and in the state illustrated in FIG. 4. As explained above, in the lighting device 1 according to this embodiment, since the light source unit 100 can tilt, it is possible to change an irradiating direction of light.

As explained in detail below, in the lighting device 1 according to this embodiment, an operator can tilt the light source unit 100 from the position illustrated in FIG. 1 to the position illustrated in FIG. 3 by inserting hands from the through-hole 300a of the decoration frame 300 and pressing the light source unit 100. Similarly, the operator can also tilt the light source unit 100 from the position illustrated in FIG. 3 to the position illustrated in FIG. 1 and can also tilt the light source unit 100 to a position between the position illustrated in FIG. 1 and the position illustrated in FIG. 3 by pressing the light source unit 100.

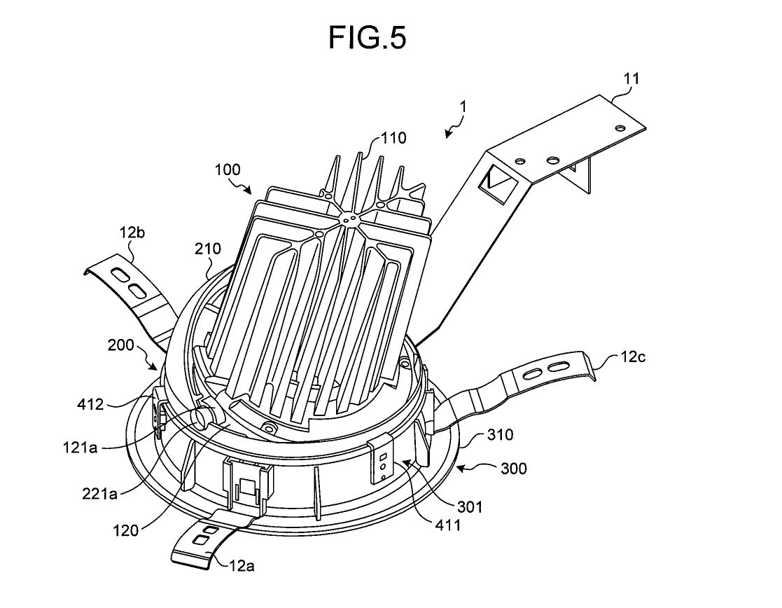

As explained above, in the lighting device 1 according to this embodiment, the rotating ring 200 can slide on the decoration frame 300 integrally with the light source unit 100. This point is explained with reference to FIG. 5. FIG. 5 is a perspective view of an example of the external appearance of the lighting device 1 according to this embodiment. In FIG. 5, an example of the lighting device 1, which is in a state in which the rotating ring 200 tilts from the state illustrated in FIG. 3, viewed from the oblique upward direction is illustrated.

In the lighting device 1 illustrated in FIG. 5, compared with the lighting device 1 illustrated in FIG. 3, the rotating ring 200 slides on the decoration frame 300 integrally with the light source unit 100. Specifically, in the lighting device 1 illustrated in FIG. 3, the supporting section 221a of the rotating ring 200 is located further on the right side than the attachment spring 12a provided in the decoration frame 300. On the other hand, in the lighting device 1 illustrated in FIG. 5, the supporting section 221a is located further on the left side than the attachment spring 12a.

If the rotating ring 200 slides as illustrated in FIG. 5, since the light source unit 100 rotates, the light-emitting surface 100a also rotates. In other words, if the rotating ring 200 slides, the irradiating direction of light by the light source unit 100 changes. In this way, in the lighting device 1 according to this embodiment, the rotating ring 200 can rotate integrally with the light source unit 100. Therefore, it is possible to change the irradiating direction of light.

As explained in detail below, in the lighting device 1 according to this embodiment, the operator can rotate the light source unit 100 together with the rotating ring 200 by inserting hands from the through-hole 300a of the decoration frame 300 and pressing the light source unit 100.

### Example of the Light Source Unit in a Disassembled State

An example of the light source unit 100 in a disassembled state according to this embodiment is explained. FIG. 6 is a perspective view of an example of the light source unit 100 in the disassembled state according to this embodiment. As illustrated in FIG. 6, the light source unit 100 includes the radiator 110, the base member 120, a thermal radiation sheet 130, the substrate 140, an optical lens 150, and the variable color filter 160.

As illustrated in FIG. 6, in the radiator 110, plural thermal radiation fins are vertically provided on the base material 111 having a substantially circular shape. The radiator 110 discharges heat generated from the substrate 140 to the outside of the lighting device 1. As illustrated in FIG. 6, in the base material 111, screw through-holes 111a and 111b through which fixing screws are inserted to fix the radiator 110 to the base member 120 are formed. Although not illustrated in the figure, a screw through-hole (a screw through-hole 111c) same as the screw through-holes 111a and 111b is formed in the base material 111. The screw through-holes 111a to 111c are formed at substantially equal intervals at the circumferential edge of the base material 111. A harness through-hole 112 through which a connection line that connects the substrate 140 and the terminal block is inserted is formed in the base material 111.

The base member 120 is formed in a cylindrical shape opened in substantially circular shapes respectively at both the upper and lower ends. The base member 120 includes the protruding sections 121a and 121b having a columnar shape protruding outward from the outer wall 120a. In the protruding section 121a, a shaft hole 122a, which is a columnar hole, is formed. Similarly, a columnar shaft hole (a shaft hole 122b) is also formed in the protruding section 121b.

Screw holes 123a to 123c into which fixing screws are screwed to fix the radiator 110 are formed at the edge of an upper end opening section of the base member 120. On an inner wall 120b of the base member 120, the projecting section 124 projecting in the inner side direction is formed on the inner wall 120b of the base member 120. The projecting section 124 supports the optical lens 150. In the projecting section 124, the cutouts sections 125a and 125b for fixing the variable color filter 160 explained later are formed.

The thermal radiation sheet 130 is made of synthetic resin having high thermal conductivity. The thermal radiation sheet 130 is formed in a plane shape having a size for enabling the thermal radiation sheet 130 to be set on the lower surface of the radiator 110 (the lower surface of the base material 111). The thermal radiation sheet 130 comes into close surface contact with both of the lower surface of the radiator 110 and the substrate 140 to closely attach the substrate 140 to the radiator 110.

The substrate 140 includes a first surface 140a on which not-illustrated light-emitting elements are mounted and a second surface 140b set on the lower surface of the radiator 110 via the thermal radiation sheet 130. One end of the connection line inserted through the harness through-hole 112 is connected to the substrate 140. The other end of the connection line is connected to the terminal block. Consequently, the substrate 140 causes the light-emitting elements to emit light with electric power supplied from the commercial alternating-current power supply via the terminal block to provide light to the inside of the room or the like.

Since the light-emitting elements generate heat when lit, it is likely that the temperature of the substrate 140 rises. However, the heat generated from the substrate 140 is conducted to the radiator 110 made of metal having high thermal conductivity via the thermal radiation sheet 130 and discharged to the atmosphere via the radiator 110.

The substrate 140 according to this embodiment is configured in an SMD (Surface Mount Device) form. Plural light-emitting elements are mounted on the first surface 140a. However, the substrate 140 is not limited to the SMD form and may be a COB (Chip on Board) form in which plural light-emitting elements are regularly arrayed and mounted on a part or all of the first surface 140a in fixed order, for example, in a matrix shape, a zigzag shape, or a radial shape.

The optical lens 150 causes light from the light-emitting elements mounted on the substrate 140 to diverge or focus. The optical lens 150 includes a lens 151 for each of the light-emitting elements. In FIG. 6, reference numeral 151 is affixed to one lens. However, members having a truncated cone shape formed on the optical lens 150 correspond to the lens 151.

In the light source unit 100 according to this embodiment, the radiator 110, to which the substrate 140 is closely attached via the thermal radiation sheet 130, and the base member 120, in which the optical lens 150 is placed on the projecting section 124, are fixed by fixing screws or the like. Specifically, the not-illustrated fixing screw is pierced through the screw through-hole 111a and screwed into the screw hole 123a. Similarly, the not-illustrated fixing screw is pierced through the screw through-hole 111b and screwed into the screw hole 123b. The not-illustrated fixing screw is pierced through the screw through-hole 111c and screwed into the screw hole 123c. Consequently, the radiator 110 and the base member 120 are fixed in a state in which the radiator 110 and the base member 120 hold the thermal radiation sheet 130, the substrate 140, and the optical lens 150.

The variable color filter 160 is a color filter that selectively transmits light having specific wavelength in the light caused to diverge or focus by the optical lens 150 to change a color of the light. The variable color filter 160 is formed in a substantially circular shape with a member having flexibility. The variable color filter 160 is formed in a size for enabling, if the variable color filer 160 is in a bent state, the variable color filter 160 to be inserted through an opening section formed by the projecting section 124 of the base member 120. The variable color filter 160 includes the projecting sections 161a and 161b projecting from the outer edge of the variable color filter 160.

The variable color filter 160 is inserted through the opening section formed by the projecting section 124 of the base member 120 from a lower part illustrated in FIG. 6, for example, in a state in which the variable color filter 160 is bent in a direction in which the projecting section 161a and the projecting section 161b come close to each other. Thereafter, if the variable color filter 160 is reset to the original state (the state illustrated in FIG. 6), the projecting section 161a is placed on the cutout section 125a of the base member 120 and the projecting section 161b is placed on the cutout section 125b. In this way, the variable color filter 160 is attached to the inside of the base member 120 from under the base member 120.

An example of the Lighting Device in a Disassembled State

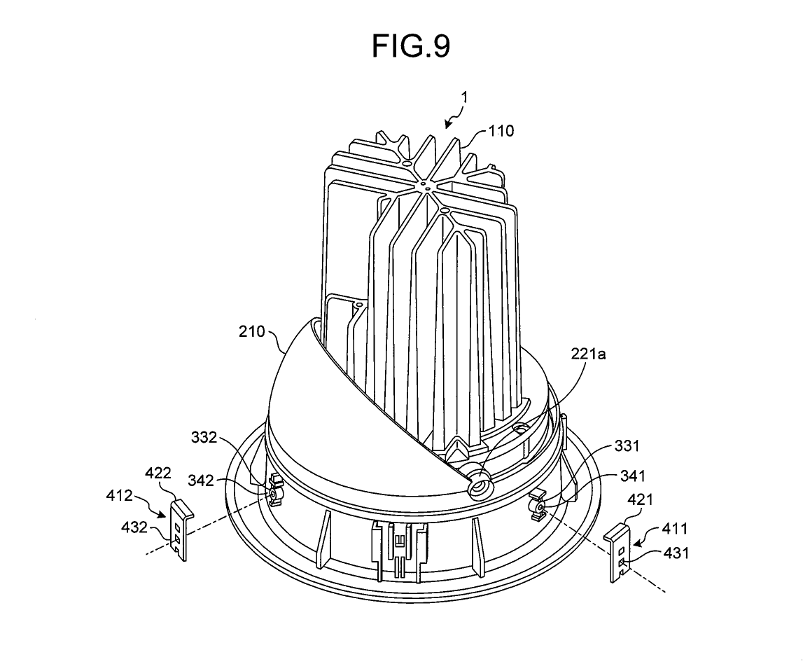

Examples of the lighting device 1 according to this embodiment in disassembled states are explained with reference to FIGS. 7 to 9. FIGS. 7 and 9 are perspective views of the examples of the lighting device 1 according to this embodiment in the disassembled states. FIG. 8 is an enlarged perspective view of an example of the external appearance of the rotating ring 200 according to this embodiment. In the following explanation, explanation of the top plate 11 and the attachment springs 12a to 12c is omitted.

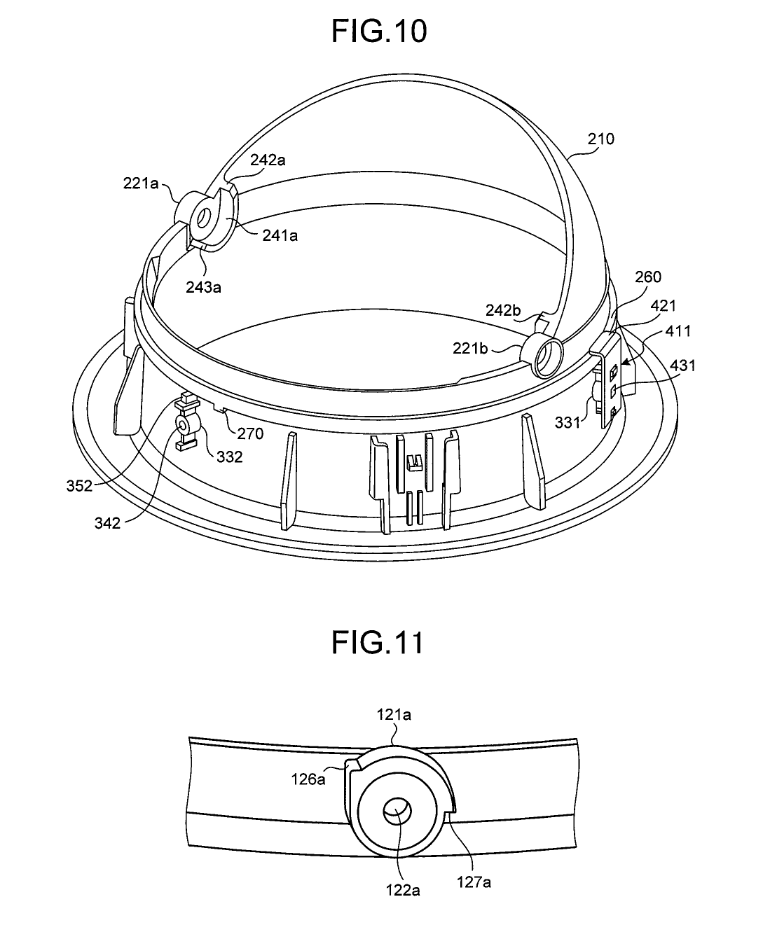

First, fixing of the light source unit 100 to the rotating ring 200 is explained. As illustrated in FIGS. 7 and 8, a shaft hole 231a is formed in the supporting section 221a of the rotating ring 200. The rotating ring 200 includes a placing section 241a projecting in the inner side direction (a direction toward the supporting section 221b) from the supporting section 221a (see FIG. 10). Similarly, as illustrated in FIGS. 7 and 8, in the rotating ring 200, a shaft hole 231b is formed in the supporting section 221b. The rotating ring 200 includes a placing section 241b projecting in the inner side direction (a direction toward the supporting section 221a) from the supporting section 221b.

The protruding section 121a of the light source unit 100 is placed on the placing section 241a and the protruding section 121b of the light source unit 100 is placed on the placing section 241b. A not-illustrated columnar shaft member is inserted into the shaft hole 231a of the supporting section 221a and the shaft hole 122a of the protruding section 121a. Similarly, a not-illustrated columnar shaft member is inserted into the shaft hole 231b and the shaft hole 122b. Consequently, the light source unit 100 is supported by the rotating ring 200 to be capable of rotating (capable of tilting) about a rotation axis, which is the straight line that connects the protruding section 121a and the protruding section 121b.

Fixing of the rotating ring 200 to the decoration frame 300 is explained. As illustrated in FIG. 8, in the rotating ring 200, a step is formed by a step surface 250 substantially parallel to an opening surface of the rotating ring 200 such that the opening surface increases in size stepwise in a direction from the upper end to the lower end of the rotating ring 200.

Specifically, the rotating ring 200 includes the first annular section 261 and the second annular section 262. The first annular section 261 slides on the edge 320 of the through-hole 300a in the decoration frame 300 to be capable of pivoting integrally with the rotating ring 200. In other words, the step surface 250, which is the edge of the first annular section 261, slides on the edge 320 of the through-hole 300a in the decoration frame 300 in a state in which the step surface 250 is placed on the edge 320.

The rotating ring 200 and the decoration frame 300 are formed such that an inner diameter L11 (see FIG. 8) in the step surface 250 of the first annular section 261 and an inner diameter L12 (see FIG. 7) at the edge 320 of the decoration frame 300 have substantially the same sizes. Consequently, when the step surface 250 is placed on the edge 320 of the decoration frame 300, the first annular section 261 forms an inner wall that is flush with the through-hole 300a in the decoration frame 300.

The second annular section 262 is formed in an inner diameter L13 larger than the inner diameter L11 of the first annular section 261. The second annular section 262 surrounds at least a part of the outer wall 301 of the decoration frame 300 (see FIG. 10). A step surface 260 (see FIG. 10) corresponding to a step between the first annular section 261 and the second annular section 262 is formed on the outer wall of the rotating ring 200.

As illustrated in FIG. 9, the decoration frame 300 includes a metal fitting attaching section 331 to which the fixing metal fitting 411 is attached and a metal fitting attaching section 332 to which the fixing metal fitting 412 is attached. Although not illustrated in the figure, the decoration frame 300 includes a metal fitting attaching section (a metal fitting attaching section 333) to which the fixing metal fitting 413 is attached. The metal fitting attaching sections 331 to 333 are formed at substantially equal intervals on the outer wall 301 of the decoration frame 300.

As illustrated in FIG. 9, a screw hole 341 into which a fixing screw is screwed to fix the fixing metal fitting 411 is formed in the metal fitting attaching section 331. Similarly, a screw hole 342 is formed in the metal fitting attaching section 332. Although not illustrated in the figure, a screw hole is also formed in the metal fitting attaching section 333.

As illustrated in FIG. 9, the fixing metal fitting 411 is formed in a hook shape, an upper part of which is bent substantially at a right angle. The fixing metal fitting 411 includes an upper plate 421. A screw through-hole 431 is formed in the fixing metal fitting 411. Similarly, the fixing metal fitting 412 includes an upper plate 422. A screw through-hole 432 is formed in the fixing metal fitting 412. Similarly, the not-illustrated fixing metal fitting 413 includes an upper plate. A screw through-hole is formed in the fixing metal fitting 413.

In the light source unit 100 according to this embodiment, as illustrated in FIG. 9, in a state in which the step surface 250 of the rotating ring 200 is placed on the edge 320 of the decoration frame 300, the fixing metal fittings 411 to 413 are fixed to the metal fitting attaching sections 331 to 333. Specifically, a not-illustrated fixing screw is pierced through the screw through-hole 431 and screwed into the screw hole 341 of the metal fitting attaching section 331. Consequently, the fixing metal fitting 411 is fixed to the metal fitting attaching section 331. Similarly, the fixing metal fitting 412 is fixed to the metal fitting attaching section 332 and the fixing metal fitting 413 is fixed to the metal fitting attaching section 333.

In this way, one ends of the fixing metal fittings 411 to 413 are attached to the outer wall 301 of the decoration frame 300 and the other ends cover the second annular section 262 of the rotating ring 200. The upper plate 421 of the fixing metal fitting 411 (the upper plates of the fixing metal fittings 412 and 413 as well) does not press the step surface 260 of the rotating ring 200 in the downward direction (the direction toward the decoration frame 300). The upper plate 421 is located above the step surface 260 in the rotating ring 200 or comes into contact with the step surface 260. Consequently, the fixing metal fittings 411 to 413 can suppress the rotating ring 200 from moving in the up down direction and can slidably fix the rotating ring 200 on the edge 320 of the through-hole 300a in the decoration frame 300.

As explained above, in the lighting device 1 according to this embodiment, when the rotating ring 200 is placed on the decoration frame 300, the first annular section 261 forms the inner wall that is flush with the through-hole 300a of the decoration frame 300. Therefore, in the lighting device 1 according to this embodiment, since a protruding section or the like is not formed in an irradiation region of the light source unit 100, it is possible to perform stable lighting using the rotatable light source unit 100. For example, if a protruding section or the like is formed in the irradiation region of the light source unit 100, a shadow is likely to be formed in the room or the like. However, with the lighting device 1 according to this embodiment, it is possible to light the inside of the room or the like without forming a shadow. Since the decoration frame 300 is likely to be directly viewed, if a protruding section is formed on the inner wall of the decoration frame 300, a fine view of the lighting device itself is spoiled. However, in the lighting device 1 according to this embodiment, since a protruding section is not formed on the inner wall of the decoration frame 300, the fine view is not spoiled and a design characteristic can be improved.

### Movable Range of the Light Source Unit

A movable range of the light source unit 100 according to this embodiment is explained with reference to FIGS. 10 and 11. FIG. 10 is an enlarged perspective view of an example of the external appearance of the rotating ring 200 and the decoration frame 300 according to this embodiment. In FIG. 10, a state in which the rotating ring 200 slides in the left direction (the clockwise direction) compared with the state illustrated in FIG. 9 is illustrated. FIG. 11 is an enlarged diagram of the protruding section 121a formed in the base member 120 according to this embodiment.

First, a tilting range of the light source unit 100 is explained. As illustrated in FIG. 10, the placing section 241a of the rotating ring 200 includes locking surfaces 242a and 243a. The placing section 241b of the rotating ring 200 includes a locking surface 242b same as the locking surface 242a. Although not illustrated in FIG. 10, the placing section 241b includes a locking surface same as the locking surface 243a.

As illustrated in FIG. 11, the protruding section 121a of the base member 120 includes a locking section 126a locked to the locking surface 242a of the rotating ring 200 and a locking section 127a locked to the locking surface 243a of the rotating ring 200.

As explained above, if the light source unit 100 is fixed to the rotating ring 200, the protruding section 121a of the base member 120 is placed on the placing section 241a of the rotating ring 200 and the protruding section 121b of the base member 120 is placed on the placing section 241b of the rotating ring 200. The tilting range of the light source unit 100 is determined by the locking sections 126a and the 127a.

Specifically, the locking section 126a of the base member 120 is locked to the locking surface 242a of the rotating ring 200 to determine a position where the light source unit 100 can tilt in a direction toward the cover 210. For example, the locking section 126a is locked to the locking surface 242a to prevent the light source unit 100 from tilting further in a direction in which the cover 210 is formed than the state illustrated in FIG. 1.

The locking section 127a of the base member 120 is locked to the locking surface 243a of the rotating ring 200 to determine a position where the light source unit 100 can tilt in a direction away from the cover 210. For example, the locking section 127a is locked to the locking surface 243a to prevent the light source unit 100 from tilting further in a direction in which the cover 210 is not formed than the state illustrated in FIG. 3.

A sliding range of the rotating ring 200 is explained. As illustrated in FIG. 10, the decoration frame 300 includes the locking section 352 in an upper part of the metal fitting attaching section 332. The decoration frame 300 does not include the locking section 352 in upper parts of the metal fitting attaching sections (the metal fitting attaching section 331 and the metal fitting attaching section 333, which is not illustrated in FIG. 10) other than the metal fitting attaching section 332. As illustrated in FIG. 10, the rotating ring 200 includes the protruding section 270 protruding from the edge of the second annular section 262 along the outer wall 301 of the decoration frame 300.

In the mechanism, the sliding range of the rotating ring 200 is determined by the protruding section 270 of the rotating ring 200 and the locking section 352 of the decoration frame 300. Specifically, the protruding section 270 of the rotating ring 200 is locked to the locking section 352 of the decoration frame 300 to determine the sliding range of the rotating ring 200. For example, in the example illustrated in FIG. 10, if the rotating ring 200 is slid in the clockwise direction and the protruding section 270 is locked to the locking section 352, the rotating ring 200 may be unable to slide in the clockwise direction. Even if the rotating ring 200 is slid in the counterclockwise direction, if the protruding section 270 is locked to the locking section 352, the rotating ring 200 may be unable to slide in the counterclockwise direction. In other words, the rotating ring 200 does not slide to rotate more than once (360°).

As explained above, the substrate 140 in the light source unit 100 attached to the rotating ring 200 is connected to, via the connection line inserted through the harness through-hole 112, the terminal block attached to the top plate 11. Therefore, if the light source unit 100 can freely rotate according to the sliding of the rotating ring 200, it is likely that the connection line is twisted or twined around the radiator 100 or the like. However, in the lighting device 1 according to this embodiment, the rotating ring 200 does not slide to rotate more than once (360°) on the decoration frame 300. Therefore, it is possible to prevent the connecting line, which connects the substrate 140 and the terminal block, from being twisted or twined around the radiator 110 or the like.

### Example of a Cross Section of the Rotating Ring and the Decoration Frame

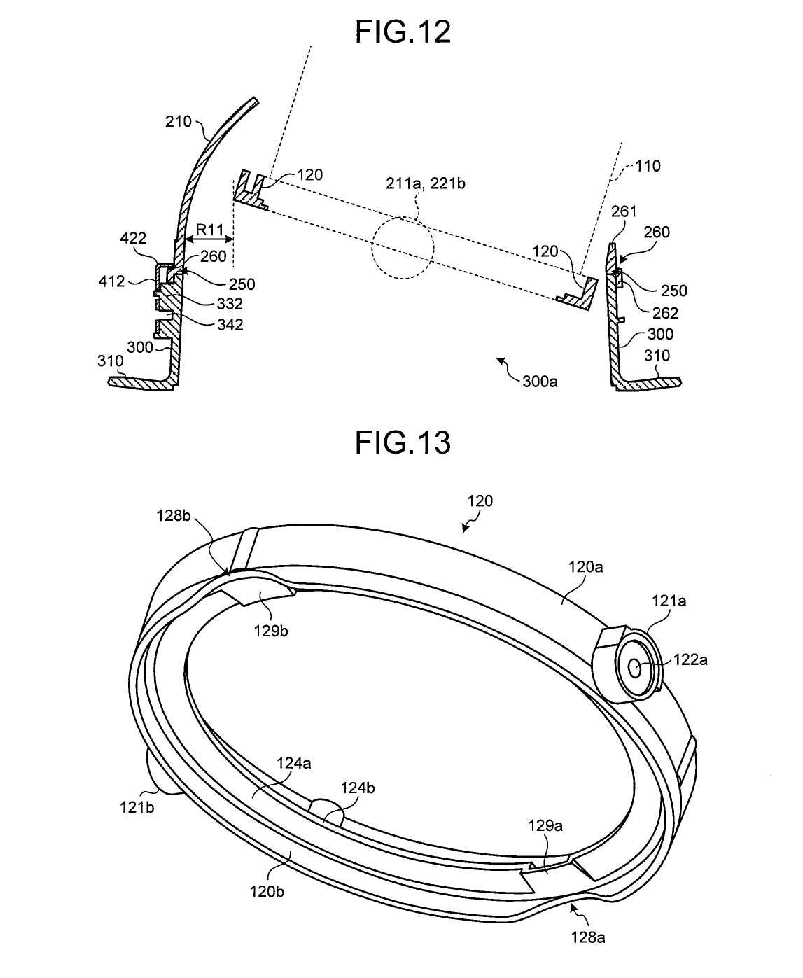

A cross section of the rotating ring 200 and the decoration frame 300 according to this embodiment is explained. FIG. 12 is a schematic diagram of the cross section of the rotating ring 200 and the decoration frame 300 according to this embodiment. In FIG. 12, a cross section of the rotating ring 200 and the decoration frame 300 taken along a line that connects the position of the fixing metal fitting 412 illustrated in FIG. 3 and the center point of the rotating ring 200 is illustrated.

As illustrated in FIG. 12, the decoration frame 300 and the first annular section 261 of the rotating ring 200 form a smooth inner wall without a step. The second annular section 262 of the rotating ring 200 surrounds the upper end of the outer wall 301 of the decoration frame 300. Consequently, the second annular section 262 can prevent the rotating ring 200 and the decoration frame 300 from shifting in the lateral direction (the sliding direction).

As illustrated in FIG. 12, the rotating ring 200 is formed by the step surfaces 250 and 260 such that the opening surface increases in size in a direction from the upper end to the lower end. The upper plate 422 of the fixing metal fitting 412 attached to the metal fitting attaching section 332 is located above the step surface 260 of the rotating ring 200. The upper plate 422 may come into contact with the step surface 260 in a degree not pressing the step surface 260 in the downward direction. Similarly, the upper plates of the fixing metal fittings 411 and 413 are located above the step surface 260 of the rotating ring 200. Consequently, the fixing metal fittings 411 to 413 can prevent the rotating ring 200 and the decoration frame 300 from coming off in the up down direction (a direction perpendicular to the sliding surface).

In the rotating ring 200, the cover 210 extending further in the upward direction than the supporting sections 221a and 221b and extending in the direction toward the supporting sections 221a and 221b is formed. As illustrated in FIG. 12, the cover 210 is formed in a shape for covering a gap R11 formed between the light source unit 100 tilting in a direction most away from the cover 210 and the rotating ring 200. In other words, the cover 210 is formed in a shape for covering at least one end of the light source unit 100 in a state in which the locking section 127a of the light source unit 100 tilts to be locked to the locking surface 243a of the rotating ring 200. Consequently, the cover 210 can cover the gap R11 formed during the tilting of the light source unit 100. Therefore, it is possible to prevent dust or the like from falling to the room or the like from the gap R11.

### Tilting Supporting Mechanism

A tilting supporting mechanism for the light source unit 100 is explained. FIG. 13 is an enlarged perspective view of an example of the external appearance of the base member 120 according to this embodiment. In FIG. 13, an example of the base member 120 illustrated in FIG. 6 viewed from an oblique downward direction is illustrated.

As illustrated in FIG. 13, the base member 120 includes the projecting section 124 formed in a cylindrical shape and projecting from the inner wall 120b in the inner side direction. In the base member 120, the cutout sections 128a and 128b are formed at the edge of the lower end opening section (the edge of the sidewall extending in the direction of the through-hole 300a). The cutout sections 128a and 128b are formed by cutting out the edge of the lower end opening section to draw a smooth curve. The cutout sections 128a and 128b are formed in positions opposed to each other and in positions where the straight line that connects the cutouts 128a and 128b and the straight line that connects the protruding sections 121a and 121b are substantially perpendicular to each other.

As illustrated in FIG. 13, a rear surface 124a of the projecting section 124 is formed such that the opening section gradually increases in size from an inner wall 124b of the projecting section 124 toward the inner wall 120b of the base member 120. The base member 120 includes, on the rear surface 124a of the projecting section 124, the flat sections 129a and 129b substantially parallel to the opening surface of the base member 120. The flat section 129a is formed near the cutout section 128a. The flat section 129b is formed near the cutout section 128b.

The base member 120 facilitates tilting operation and pivoting operation of the light source unit 100 by the operator. Specifically, the operator can insert hands into the through-hole 300a from under the decoration frame 300 and put fingers on the cutout sections 128a and 128b. As explained above, the rear surface 124a of the projecting section 124 is a slope. However, since the flat sections 129a and 129b are formed near the cutout sections 128a and 128b, the operator can put the fingers on the cutout sections 128a and 128b in a stable state. Consequently, the operator can easily tilt and pivot the light source unit 100. For example, in a state in which the operator puts the fingers on the cutout sections 128a and 128b, the operator can easily tilt the light source unit 100 by pressing one of the flat sections 129a and 129b. For example, in the state in which the operator puts the fingers on the cutout sections 128a and 128b, the operator can easily pivot the light source unit 100 by pressing the sidewalls of the cutout sections 128a and 128b.

### Attaching and Detaching Mechanism for the Variable Color Filter

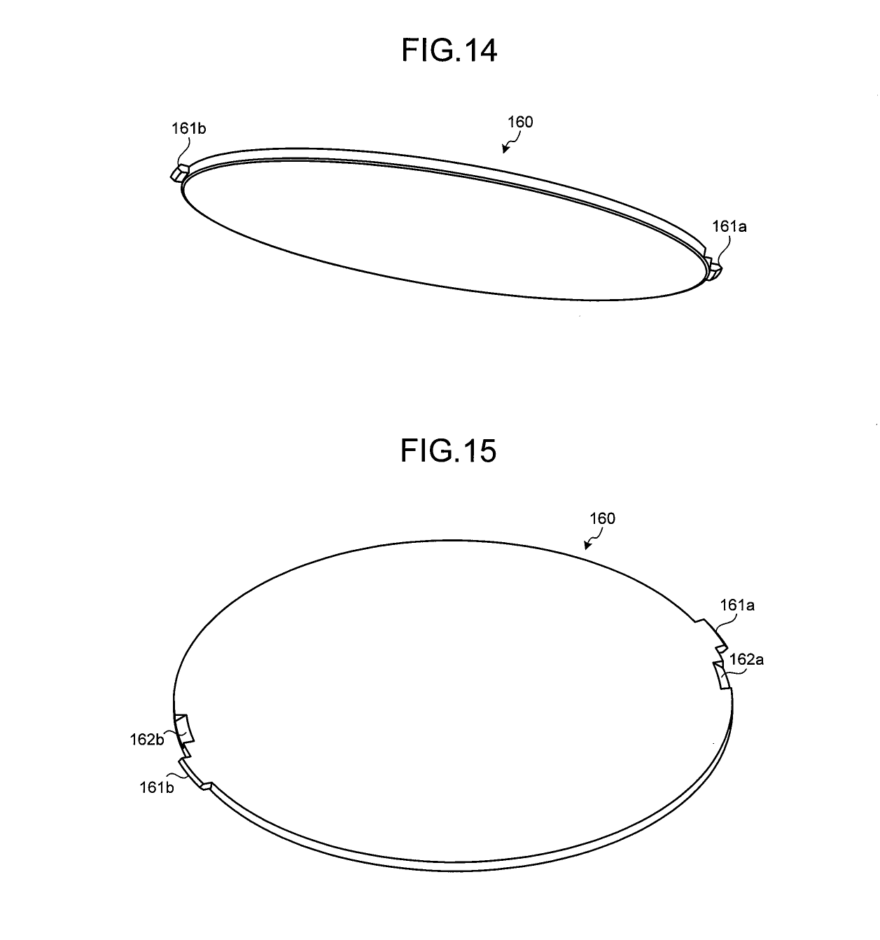

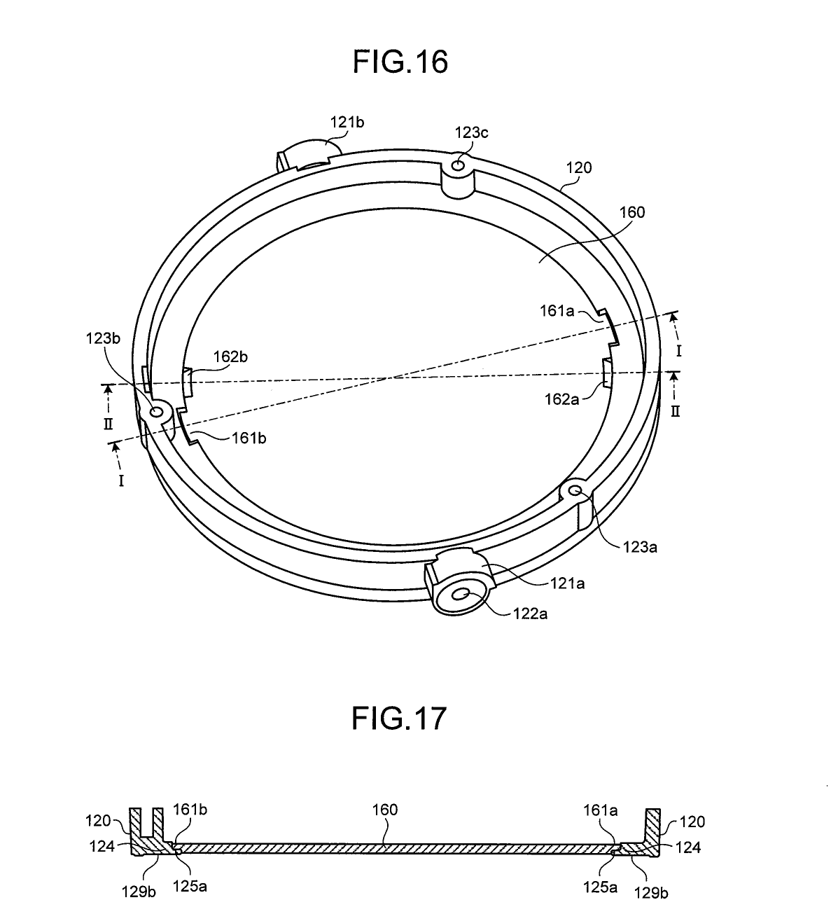

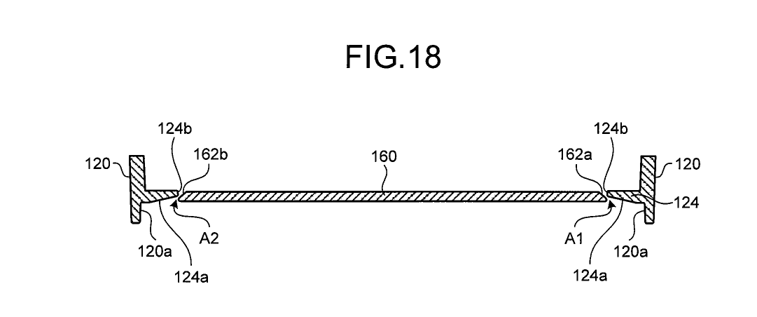

An attaching and detaching mechanism for the variable color filter 160 is explained with reference to FIGS. 14 to 18. FIGS. 14 and 15 are enlarged perspective views of an example of the external appearance of the variable color filter 160 according to this embodiment. In FIG. 14, an example of the variable color filter 160 illustrated in FIG. 6 viewed from the oblique downward direction is illustrated. In FIG. 15, an example of the variable color filter 160 illustrated in FIG. 6 viewed from the obliquely upward direction is illustrated. FIG. 16 is an enlarged perspective view of an example of the external appearance of the base member 120 mounted with the variable color filter 160. In FIG. 16, an example of the base member 120 illustrated in FIG. 6 viewed from the oblique upward direction is illustrated. FIG. 17 is a schematic diagram of a cross section taken along line I-I illustrated in FIG. 16. FIG. 18 is a schematic diagram of a cross section taken along line II-II illustrated in FIG. 16.

As illustrated in FIG. 14, the variable color filter 160 includes the projecting sections 161a and 161b on the sidewall. As illustrated in FIG. 15, the cutout sections 162a and 162b are formed on the upper surface of the variable color filter 160. The upper surface of the variable color filter 160 indicates a surface opposed to the optical lens 150 when the variable color filter 160 is attached to the lighting device 1.

As explained above, the variable color filter 160 is inserted from under the decoration frame 300 and attached to the base member 120. As illustrated in FIGS. 16 and 17, when the variable color filter 160 is attached to the base member 120, the projecting section 161a is placed on the cutout section 125a of the base member 120 and the projecting section 161b is placed on the cutout section 125b.

As illustrated in FIG. 18, the rear surface 124a of the projecting section 124 is formed in an inclined shape such that the opening section gradually increases in size from the inner wall 124b of the projecting section 124 toward the inner wall 120b of the base member 120. Therefore, as illustrated in FIG. 18, a gap A1 is formed between the projecting section 124 and the cutout section 162a of the variable color filter 160. Similarly, a gap A2 is formed between the projecting section 124 and the cutout section 162b of the variable color filter 160. Consequently, the operator can bend the variable color filter 160 by putting fingers in the gaps A1 and A2. Therefore, the operator can easily remove the variable color filter 160 from the base member 120.

As explained above, in the lighting device 1 according to this embodiment, even in a state in which the lighting device 1 is embedded and set in the ceiling, it is possible to easily attach the variable color filter 160 to the light source unit 100 from the outside and easily remove the variable color filter 160 from the light source unit 100.

### Effects of the Embodiment

As explained above, in the lighting device 1 according to the embodiment, the rotating ring 200 includes the supporting sections 221a and 221b configured to support the light source unit 100 to be rotatable about a rotation axis that connects opposed positions of the inner wall of the rotating ring 200, the first annular section 261 configured to form an inner wall that is flush with the through-hole 300a of the decoration frame 300 and slide on the edge 320 of the through-hole 300a to be capable of pivoting integrally with the light source unit 100, and the second annular section 262 formed with an inner diameter larger than the inner diameter of the first annular section 261 and configured to surround at least a part of the outer wall 301 of the decoration frame 300. Consequently, with the lighting device 1 according to this embodiment, since a step such as a protruding section is not formed on the inner wall of the lighting device 1, it is possible to perform stable lighting using the light source unit 100.

In the lighting device 1 according to the embodiment, one ends of the fixing metal fittings 411, 412, and 413 are attached to the outer wall 301 of the decoration frame 300 and the other ends cover the second annular section 262 of the rotating ring 200. Consequently, with the lighting device 1 according to this embodiment, it is possible to suppress the rotating ring 200 from coming off the decoration frame 300 and slidably fix the rotating ring 200 on the edge 320 of the through-hole 300a.

In the lighting device 1 according to this embodiment, the rotating ring 200 includes the protruding section 270 protruding from the second annular section 262 along the outer wall 301 of the decoration frame 300. The decoration frame 300 includes the locking section 352 for locking the protruding section 270. Consequently, with the lighting device 1 according to this embodiment, since the rotating ring 200 does not slide to rotate more than once, it is possible to prevent the connection line that connects the substrate 140 and the terminal block from being twisted or being twined around the radiator 110 or the like.

In the lighting device 1 according to this embodiment, the light source unit 100 includes the cylindrical base member 120 supported by the supporting sections 221a and 221b in the opposed positions of the outer wall. In the base member 120, the cutout sections 128a and 128b are formed at the edge of the lower end opening section opened in the direction toward the through-hole 300a of the decoration frame 300. Consequently, with the lighting device 1 according to this embodiment, it is possible to facilitate the tilting operation and the pivoting operation of the light source unit 100.

### Other Embodiments

In the embodiment explained above, the downlight type embedded and set in the ceiling is explained as an example. However, the lighting device 1 can be applied to a lighting device fixture or the like attached to the surface of the ceiling or the wall other than the type embedded and set in the ceiling.

The lighting device 1 according to the embodiment does not need to include all the members described in the embodiment and the figures. For example, the lighting device 1 does not have to include the top plate 11. Rather than the three fixing metal fittings 411, 412, and 413, the lighting device 1 may include two fixing metal fittings or may include four or more fixing metal fittings. The lighting device 1 may include a locking section same as the locking section 352 in the upper part of the metal fitting attaching section 331 or the metal fitting attaching section 333 in addition to the upper part of the metal fitting attaching section 332. The lighting device 1 can control the sliding range of the rotating ring 200 to half rotation or the like by including plural locking sections such as the locking section 352.

The shapes, the raw materials, and the materials of the members according to the embodiment are not limited to the examples described in the embodiment and the figures. For example, the base member 120 and the like do not have to be columnar.

In the example explained in the embodiment, the members are fixedly provided by the fixing screws. However, in the lighting device 1, the members may be fixedly provided by fixing members such as pins other than the fixing screws.

As explained above, according to the embodiment, it is possible to perform stable lighting using the rotatable light source.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. A lighting device comprising:
a cylindrical decoration frame in which a through-hole is formed;
a light source unit mounted with a light-emitting element; and
a rotating ring including:
a supporting section configured to support the light source unit to be rotatable about a rotation axis that connects opposed positions of an inner wall of the rotating ring;
a first annular section having an inner wall that forms an opening that is contiguous with the through-hole of the decoration frame and is configured to slide on an edge of the decoration frame; and
a second annular section formed with an inner diameter larger than an inner diameter of the first annular section and configured to surround at least a part of an outer wall of the decoration frame.

2. The lighting device according to claim 1, further comprising a fixing member, one end of which is attached to the outer wall of the decoration frame and the other end of which covers the second annular section of the rotating ring.

3. The lighting device according to claim 1, wherein
the rotating ring includes a protruding section protruding from the second annular section, and
the decoration frame includes, on the outer wall, a locking section for locking the protruding section.

4. The lighting device according to claim 1, wherein
the light source unit includes a cylindrical base member supported by the supporting section at opposed positions of an outer wall of the base member, wherein
in the base member, a first cutout section is formed at an edge of a section of the base member that opens in a direction toward the through-hole of the decoration frame.

5. The lighting device according to claim 4, wherein, in the base member, a pair of the first cutout sections are formed at the edge of the section of the base member, and a straight line that connects the two first cutout sections and the rotation axis are substantially perpendicular to each other.

6. The lighting device according to claim 4, further comprising a variable color filter configured to selectively transmit light having specific wavelength, wherein
the base member includes a first projecting section projecting inwardly from an inner wall of the base member, and
the variable color filter is sized to be inserted into a second opening section formed by the first projecting section from a side of the through-hole of the decoration frame, and has a second projecting section projecting from an outer edge section of the variable color filter that is placed on the first projecting section of the base member.

7. The lighting device according to claim 6, wherein, in the base member, a second cutout section for locking the second projecting section is formed in amounting surface of the first projecting section on which the second projecting section of the variable color filter is mounted.

8. The lighting device according to claim 6, wherein the variable color filter includes a third cutout section, a part of a peripheral edge of which is cut.

9. The lighting device according to claim 8, wherein a gap is formed between the base member and the third cutout section of the variable color filter after the variable color filter has been mounted on the first projecting section.

10. The lighting device according to claim 8, wherein an opposite side of a mounting surface of the first projecting section is sloped to form a gap between the base member and the third cutout section.

11. The lighting device according to claim 4, wherein the base member includes a flat section substantially parallel to an opening surface of the second opening section is formed near the first cutout section on an opposite side of a mounting surface of the first projecting section.

12. The lighting device according to claim 1, wherein the rotating ring includes a cover member configured to cover at least a part of the light source unit.

13. The lighting device according to claim 12, wherein the cover member covers a gap formed between the light source unit and the first annular section.

14. A method of positioning a light source unit having a light-emitting element and mounted in a lighting device that includes a cylindrical frame in which a through-hole is formed and a rotating ring including a supporting section configured to support the light source unit to be rotatable about a rotation axis that connects opposed positions of an inner wall of the rotating ring, a first annular section having an inner wall that forms an opening that is contiguous with the through-hole of the cylindrical frame and is configured to slide on an edge of the cylindrical frame, and a second annular section formed with an inner diameter larger than an inner diameter of the first annular section and configured to surround at least a part of an outer wall of the cylindrical frame, the method comprising:
accessing a base member of the light source unit that is supported by the rotating ring via the through-hole of the cylindrical frame;
pivoting the light source unit about a central axis of the through-hole of the cylindrical frame to a desired position; and
tilting the light source unit about the rotation axis a desired angle.

15. The method of claim 14, wherein the base member includes a pair of the first cutout sections that are accessible via the through-hole of the cylindrical frame and using which the light source unit is pivoted and tilted.

16. The method of claim 15, wherein a straight line that connects the first cutout sections and the rotation axis are substantially perpendicular to each other.

17. The method of claim 14, wherein the rotating ring includes a protruding section protruding from the second annular section, and the cylindrical frame includes, on the outer wall, a locking section for locking the protruding section so that the light source unit can no longer be pivoted.

18. A lighting device comprising:
a cylindrical frame;
a light source unit having a light-emitting element that is mounted to the cylindrical frame through a rotating ring so as to be pivotable about a central axis of the cylindrical frame and rotatable about a rotational axis that bisects the rotating ring, the rotating ring including:
a first annular section having an inner wall that forms an opening that is contiguous with an inner opening of the cylindrical frame and is configured to slide on an edge of the cylindrical frame when the light source unit is pivoted about the central axis of the cylindrical frame; and
a second annular section formed with an inner diameter larger than an inner diameter of the first annular section and configured to surround at least a part of an outer wall of the cylindrical frame.

19. The lighting device according to claim 18, further comprising a fixing member, one end of which is attached to the outer wall of the cylindrical frame and the other end of which covers the second annular section of the rotating ring.

20. The lighting device according to claim 18, wherein
the rotating ring includes a protruding section protruding from the second annular section, and
the cylindrical frame includes, on the outer wall, a locking section for locking the protruding section.
